(19) United States
(12) Patent Application Publication
(10) Pub. No.: US 2019/0056563 A1
(43) Pub. Date: Feb. 21, 2019

(54) Lens Structure

(71) Applicants: Sintai Optical (Shenzhen) Co., Ltd., ShenZhen City (CN); Asia Optical Co., Inc., Taichung (TW)

(72) Inventors: Chun-Chieh Lin, Taichung (TW); Che-Hao Chuang, Taichung (TW)

(21) Appl. No.: 15/968,821

(22) Filed: May 2, 2018

(30) Foreign Application Priority Data
Aug. 16, 2017 (CN) 201710702396.8

(51) Int. Cl. G02B 7/02; G02B 5/00

(52) U.S. Cl. CPC G02B 7/021; G02B 5/005

(57) ABSTRACT

A lens structure includes a lens barrel, a first lens and an opaque layer. The lens barrel has an axially-extended accommodation space. The first lens includes a surface and is disposed in the accommodation space, wherein the surface includes a light penetrating zone, and the light penetrating zone includes an optical axis passing through a center of the first lens. The opaque layer is formed on the surface and disposed between the light penetrating zone and the lens barrel. The lens structure satisfies: 0.2≤R/HO≤0.8, wherein R is an effective radius of the first lens, and HO is half of an outer diameter of the first lens.

### BACKGROUND OF THE INVENTION

### Field of the Invention

The invention relates to a lens structure, and more particularly to a lens structure having a printed shade.

### Description of the Related Art

Referring to FIG. 1, a prior lens structure 1 includes a first lens 3, a second lens 5, a shade 7 and a lens barrel 9. The first lens 3, the second lens 5 and the shade 7 are disposed in the lens barrel 9. The shade 7 is sandwiched between the first lens 3 and the second lens 5 to determine amount of light entering the lens structure 1.

Due to the shade 7 sandwiched between the first lens 3 and the second lens 5, however, the tolerance of an air gap between the first lens 3 and the second lens 5 is increased and the curve of modulation transfer function of the lens structure 1 is affected.

In addition, since demand for thin lens structure is increased, a lens used in the lens structure usually has an elongated appearance in side view. The elongated lens is deficient in strength, and thereby susceptible to deformation during assembly of the lens structure. To solve the above described problem, thickness of the lens is increased as much as possible. In the above described lens structure, however, the shade 7 sandwiched between the first lens 3 and the second lens 5 limits increment of the thickness of the first lens 3. Therefore, the problem that the first lens 3 is deficient in strength and unable to avoid deformation has not been effectively addressed.

In sum, the arrangement of the shade 7 in the lens structure 1 causes two issues: the tolerance of the air gap between the first lens 3 and the second lens 5 is increased; and the required increment of the thickness of the first lens 3 is subject to limitations.

### BRIEF SUMMARY OF THE INVENTION

The invention provides a lens structure including a lens on which an opaque layer is directly formed. The opaque layer substitutes for the prior shade disposed in the prior lens structure for reducing the tolerance of the air gap between the lenses and facilitating increment of thickness of the lens.

A lens structure in accordance with an embodiment of the invention includes a lens barrel, a first lens and an opaque layer. The lens barrel has an axially-extended accommodation space. The first lens includes a surface and is disposed in the accommodation space, wherein the surface includes a light penetrating zone, and the light penetrating zone includes an optical axis passing through a center of the first lens. The opaque layer is formed on the surface and disposed between the light penetrating zone and the lens barrel. The lens structure satisfies: 0.2≤R/HO≤0.8, wherein R is an effective radius of the first lens, and HO is half of an outer diameter of the first lens.

In another embodiment, the lens structure further includes a second lens placed against the first lens, wherein the first lens further includes a raised portion, the raised portion protrudes from a part of the surface between the light penetrating zone and a junction of the lens barrel and the first lens, and pushes against the second lens.

In yet another embodiment, the lens structure further satisfies: 0.2≤A/R≤0.7, wherein A is a width of the raised portion, and R is the effective radius of the first lens.

In another embodiment, the optical axis passes through a center of the second lens, and the opaque layer extends from the raised portion towards the optical axis.

In yet another embodiment, the lens structure further satisfies: 0.1 mm≤B≤1 mm, wherein B is a width of the opaque layer.

In another embodiment, the lens structure further satisfies: 0.05≤B/HO≤0.6, wherein B is the width of the opaque layer, and HO is half of the outer diameter of the first lens.

In yet another embodiment, the lens structure further satisfies: 0.2≤B/HO≤0.8, wherein B is the width of the opaque layer, and HO is half of the outer diameter of the first lens.

In another embodiment, amount of light entering the lens structure is determined by the size of the opaque layer.

In yet another embodiment, the opaque layer is formed by printing to partly cover the surface.

A lens structure in accordance with another embodiment of the invention includes a lens barrel and a first lens. The lens barrel has an axially-extended accommodation space. The first lens is disposed in the accommodation space and includes an optical portion and a non-optical portion, wherein the optical portion is surrounded by the non-optical portion. The lens structure satisfies: 0.2≤R/HO≤08, wherein R is an effective radius of the first lens, and HO is half of an outer diameter of the first lens.

In another embodiment, the lens structure further satisfies: 0.1 mm≤B≤1 mm, wherein B is a width of the non-optical portion.

In yet another embodiment, the lens structure further satisfies: 0.05≤B/HO≤0.6, wherein B is the width of the non-optical portion, and HO is half of the outer diameter of the first lens.

In another embodiment, the lens structure further satisfies: 0.2≤B/HO≤0.8, wherein B is the width of the non-optical portion, and HO is half of the outer diameter of the first lens.

In yet another embodiment, amount of light entering the lens structure is determined by the size of the non-optical portion.

In another embodiment, the non-optical portion is formed by printing to partly cover the surface.

A lens structure in accordance with an embodiment of the invention includes a lens barrel, a first lens and an opaque layer. The lens barrel has an axially-extended accommodation space. The first lens includes a surface and is disposed in the accommodation space, wherein the surface includes a light penetrating zone, and the light penetrating zone includes an optical axis passing through a center of the first lens. The opaque layer is formed on the surface and disposed between the light penetrating zone and the lens barrel. The lens structure satisfies: 0.1 mm≤B≤1 mm and 0.2≤R/HO≤08, wherein B is a width of the opaque layer, R is an effective radius of the first lens, and HO is half of an outer diameter of the first lens.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a sectional view of a prior lens structure;

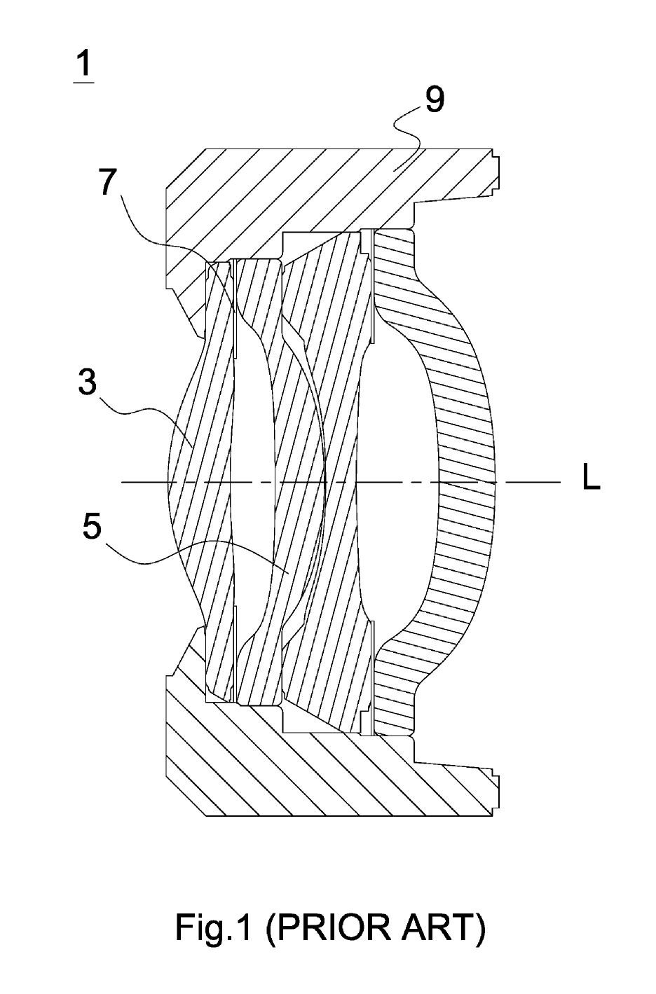

FIG. 2 is a sectional view of a lens structure in accordance with a first embodiment of the invention;

FIG. 3 is a sectional view of a first lens of FIG. 2;

FIG. 4 is a sectional view of a first lens of a lens structure in accordance with a second embodiment of the invention.

### DETAILED DESCRIPTION OF THE INVENTION

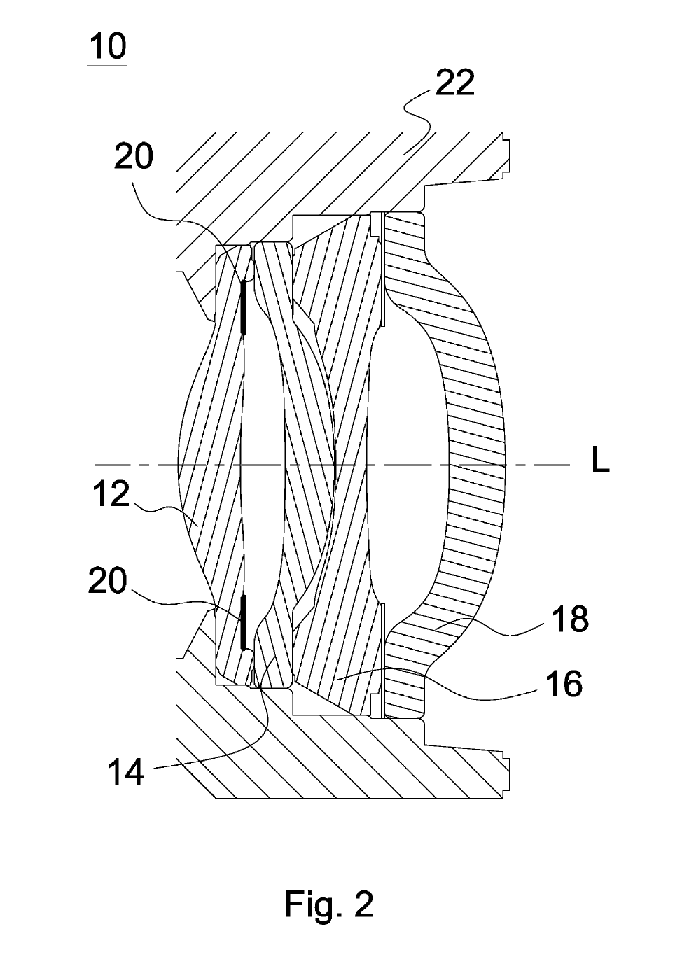

Referring to FIG. 2, a lens structure 10 in accordance with a first embodiment of the invention includes a first lens 12, a second lens 14, a third lens 16, a fourth lens 18, an opaque layer 20 (represented with thick lines) and a lens barrel 22. The first lens 12, the second lens 14, the third lens 16 and the fourth lens 18 are sequentially disposed in the lens barrel 22. Moreover, the lens structure 10 has an optical axis L sequentially passing through centers of the first lens 12, the second lens 14, the third lens 16 and the fourth lens 18.

In FIGS. 2-4, the thick lines are used only for easily identifying the opaque layer 20 without implying the actual thickness of the opaque layer 20.

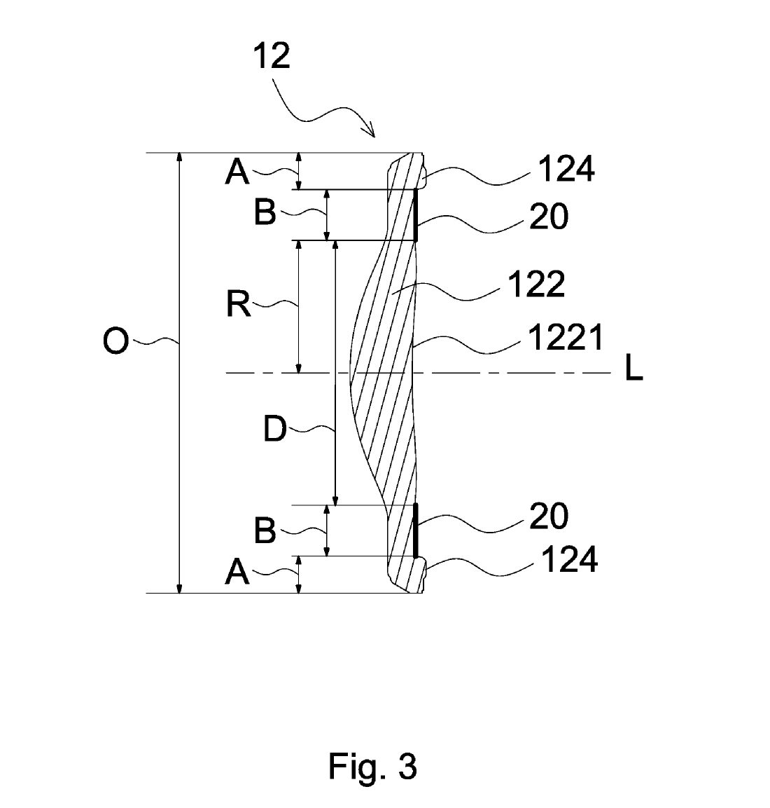

Referring to FIG. 3, the first lens 12 includes a main body 122 and a raised portion 124. The main body 122 has a first surface 1221 facing the second lens 14. As shown in FIG. 2, the raised portion 124 extends from the first surface 1221 and pushes against the second lens 14. In present embodiment, the raised portion 124 extending from the first surface 1221 increases the thickness of the first lens 12.

As shown in FIG. 3, the opaque layer 20 is formed to partly cover the first surface 1221 and extends from the raised portion 124 towards the optical axis L (FIG. 3 depicts that the opaque layer 20 substantially extends in a radius direction of the first lens 12, and the term “substantially” as used herein refers to that the first surface 1221 partly covered by the opaque layer 20 is not necessarily perpendicular to the optical axis L. Actually, the first surface 1221 may be an arc surface). Further, the opaque layer 20 can be formed by printing, for example, printing black ink to partly cover the first surface 1221 by a printing machine.

During operation, external light (not shown) entering the first lens 12 can only pass through a part of the first surface 1221 which is not covered by the opaque layer 20 (that is, the light can only pass through a light penetrating zone or an optical portion of the first lens 12). In other words, amount of the light entering the interior of the lens structure 10 is determined by the size of the other part of the first surface 1221 which is covered by the opaque layer 20 (that is, a light shielding zone or a non-optical portion of the first lens 12).

Referring to FIG. 3 and Table 1, specifically, the f-number (F) of the lens structure 10 is 1.5, 3 or 4, and the effective focal length (EFL) is 3.69 mm. An outer diameter O of the first lens 12 is substantially 3.3 mm. The above described light penetrating zone has different effective diameters D when the f-number is different. According to the formula of the effective diameter D=EFL÷F, the effective diameter D is substantially 2.46, 1.23 or 0.9225 mm. Half of the effective diameter D is the effective radius R. According to the formula of the effective radius R=D÷2, the effective radius R is substantially 1.23, 0.62 or 0.46 mm. Moreover, a width A of the raised portion 124 is substantially 0.277 mm. According to the formula of a width B of the opaque layer 20: B=(O−D)÷2−A, the width B of the opaque layer 20 is substantially 0.14, 0.76 or 0.91 mm. That is, the width B ranges substantially from 0.1 mm to 1 mm.

In addition, Table 1 shows a ratio of the effective radius R to half of the outer diameter HO (the ratio of R to HO equals to \sqrt{A₁}/\sqrt{A₂}, where A₁ is the area of the above described light penetrating zone and A₂ is the area of the first surface 1221), a ratio of the width A of the raised portion 124 to the effective radius R and a ratio of the width B of the opaque layer 20 to half of the outer diameter HO (the ratio of B to HO equals to \sqrt{A₃}/\sqrt{A₂}, where A₃ is the area of the above described light shielding zone and A₂ is the area of the first surface 1221). As shown, the ratio of the effective radius R to half of the outer diameter HO ranges from 0.2 to 0.8. The ratio of the width A of the raised portion 124 to the effective radius R ranges from 0.2 to 0.7. The ratio of the width B of the opaque layer 20 to half of the outer diameter HO ranges from 0.05 to 0.6. It is worth noting that external stray light can be effectively prevented from entering the interior of the lens structure 10 when the ratio of the effective radius R to half of the outer diameter HO or the ratio of the width B of the opaque layer 20 to half of the outer diameter HO falls in the above described ranges.

TABLE 1

| | F-number | | |
|---|---|---|---|
| | 1.5 | 3 | 4 |
| effective focal length (mm) | 3.69 | | |
| outer diameter O (mm) | 3.3 | | |
| half of the outer diameter HO (mm) | 1.65 | | |
| effective diameter D (mm) | 2.46 | 1.23 | 0.9225 |
| effective radius R (mm) | 1.23 | 0.62 | 0.46 |
| width A of the raised portion 124 (mm) | 0.277 | | |
| width B of the opaque layer 20 (mm) | 0.14 | 0.76 | 0.91 |
| ratio of the effective radius R to half of the | 0.75 | 0.37 | 0.28 |
| outer diameter HO | | | |
| ratio of the width A of the raised portion | 0.23 | 0.45 | 0.6 |
| 124 to the effective radius R | | | |
| ratio of the width B of the opaque layer 20 | 0.09 | 0.46 | 0.55 |
| to half of the outer diameter HO | | | |
| width B′ of the opaque layer 20 (mm) | 0.42 | 1.04 | 1.19 |
| ratio of the width B′ of the opaque layer 20 | 0.25 | 0.63 | 0.72 |
| to half of the outer diameter HO | | | |

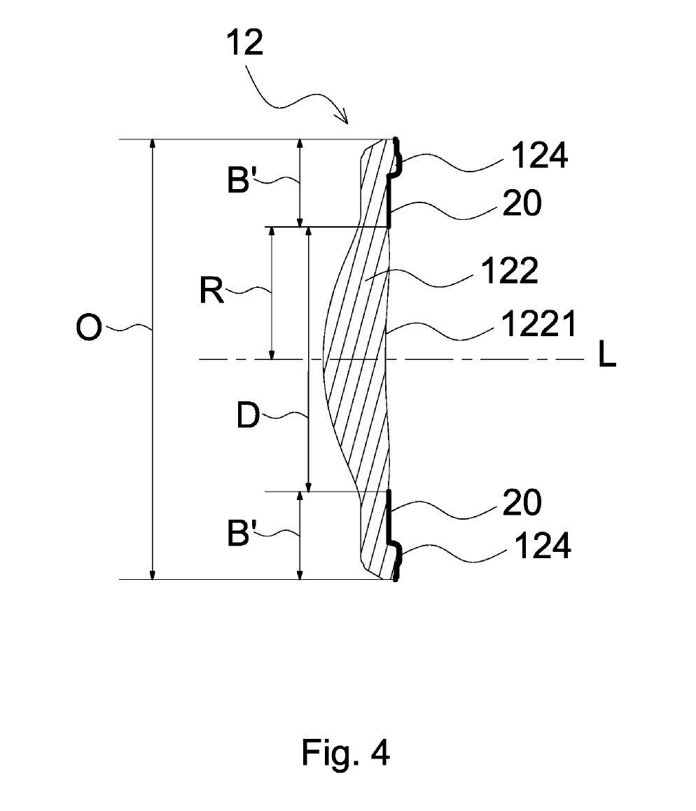

Referring to FIG. 4, in a second embodiment, the opaque layer 20 extends from an outer edge (substantially at the junction of an inner wall of the lens barrel 22 and the first lens 12) of the first lens 12 towards the optical axis L. Specifically, the opaque layer 20 is formed not only on a part of the first surface 1221 (or to partly cover the first surface 1221 as described in the first embodiment) but also on a surface of the raised portion 124. As shown in Table 1, according to the formula of a width B′ of the opaque layer 20: B′=(O−D)÷2, the width B′ of the opaque layer 20 is substantially 0.42, 1.04 or 1.19 mm, and a ratio of the width B′ of the opaque layer 20 to half of the outer diameter HO (the ratio of B′ to HO equals to \sqrt{A₄}/\sqrt{A₂}, where A₄ is the area of a light shielding zone and A₂ is the area of the first surface 1221 in the second embodiment) ranges from 0.2 to 0.8. The arrangement of other elements and operation of the second embodiment are similar to those of the first embodiment, and therefore the descriptions thereof are omitted. Similarly, external stray light can be effectively prevented from entering the interior of the lens structure 10 when the ratio of the effective radius R to half of the outer diameter HO or the ratio of the width B′ of the opaque layer 20 to half of the outer diameter HO falls in the above described ranges.

In above described structure, the opaque layer 20 is directly formed on the first surface 1221 of the first lens 12 to substitute for the prior shade. The lens structure 10 of the invention therefore has the following merits: (1) reducing the tolerance of the air gap between the first lens 12 and the second lens 14 so as to alleviate the downward trend of the curve of modulation transfer function of the lens structure 10, (2) allowing the first lens 12 to have sufficient thickness and structural strength so as to reduce the waste product (because of insufficient structural strength) produced during assembly, and (3) improving the problems such as decreased lens centering precision or lens tilt.

What is claimed is:

1. A lens structure, comprising:
a lens barrel having an axially-extended accommodation space;
a first lens comprising a surface and disposed in the accommodation space, wherein the surface comprises a light penetrating zone, and the light penetrating zone comprises an optical axis passing through a center of the first lens; and
an opaque layer formed on the surface and disposed between the light penetrating zone and the lens barrel;
wherein the lens structure satisfies:
0.2≤R/HO≤0.8;
wherein R is an effective radius of the first lens, and HO is half of an outer diameter of the first lens.

2. The lens structure as claimed in claim 1, further comprising a second lens placed against the first lens, wherein the first lens further comprises a raised portion, the raised portion protrudes from a part of the surface between the light penetrating zone and a junction of the lens barrel and the first lens, and pushes against the second lens.

3. The lens structure as claimed in claim 2, wherein the lens structure further satisfies:
0.2≤A/R≤0.7;
wherein A is a width of the raised portion, and R is the effective radius of the first lens.

4. The lens structure as claimed in claim 2, wherein the optical axis passes through a center of the second lens, and the opaque layer extends from the raised portion towards the optical axis.

5. The lens structure as claimed in claim 1, wherein the lens structure further satisfies:
0.1 mm≤B≤1 mm;
wherein B is a width of the opaque layer.

6. The lens structure as claimed in claim 5, wherein the lens structure further satisfies:
0.05≤B/HO≤0.6;
wherein B is the width of the opaque layer, and HO is half of the outer diameter of the first lens.

7. The lens structure as claimed in claim 5, wherein the lens structure further satisfies:
0.2≤B/HO≤0.8;
wherein B is the width of the opaque layer, and HO is half of the outer diameter of the first lens.

8. The lens structure as claimed in claim 4, wherein amount of light entering the lens structure is determined by the size of the opaque layer.

9. The lens structure as claimed in claim 8, wherein the opaque layer is formed by printing to partly cover the surface.

10. A lens structure, comprising:
a lens barrel having an axially-extended accommodation space; and
a first lens disposed in the accommodation space and comprising an optical portion and a non-optical portion, wherein the optical portion is surrounded by the non-optical portion;
wherein the lens structure satisfies:
0.2≤R/HO≤0.8;
wherein R is an effective radius of the first lens, and HO is half of an outer diameter of the first lens.

11. The lens structure as claimed in claim 10, wherein the lens structure further satisfies:
0.1 mm≤B≤1 mm;
wherein B is a width of the non-optical portion.

12. The lens structure as claimed in claim 11, wherein the lens structure further satisfies:
0.05≤B/HO≤0.6;
wherein B is a width of the non-optical portion, and HO is half of the outer diameter of the first lens.

13. The lens structure as claimed in claim 11, wherein the lens structure further satisfies:
0.2≤B/HO≤0.8;
wherein B is the width of the non-optical portion, and HO is half of the outer diameter of the first lens.

14. The lens structure as claimed in claim 10, wherein amount of light entering the lens structure is determined by the size of the non-optical portion.

15. The lens structure as claimed in claim 14, wherein the non-optical portion is formed by printing to partly cover the surface.

16. A lens structure, comprising:
a lens barrel having an axially-extended accommodation space;
a first lens comprising a surface and disposed in the accommodation space, wherein the surface comprises a light penetrating zone, and the light penetrating zone comprises an optical axis passing through a center of the first lens; and
an opaque layer formed on the surface and disposed between the light penetrating zone and the lens barrel;
wherein the lens structure satisfies:
0.1 mm≤B≤1 mm;
0.2≤R/HO≤08;
wherein B is a width of the opaque layer, R is an effective radius of the first lens, and HO is half of an outer diameter of the first lens.

17. The lens structure as claimed in claim 16, wherein the lens structure further satisfies:
0.05≤B/HO≤0.6;
wherein B is the width of the opaque layer, and HO is half of the outer diameter of the first lens.

18. The lens structure as claimed in claim 16, wherein the lens structure further satisfies:
0.2≤B/HO≤0.8;
wherein B is the width of the opaque layer, and HO is half of the outer diameter of the first lens.

19. The lens structure as claimed in claim 16, further comprising a second lens placed against the first lens, wherein the first lens further comprises a raised portion, the raised portion protrudes from a part of the surface between the light penetrating zone and a junction of the lens barrel and the first lens, and pushes against the second lens.

20. The lens structure as claimed in claim 19, wherein the lens structure further satisfies:
0.2≤A/R≤0.7;
wherein A is a width of the raised portion, and R is the effective radius of the first lens.
